(19) United States
(12) Patent Application Publication
(10) Pub. No.: US 2009/0024275 A1
(43) Pub. Date: Jan. 22, 2009

(54) Integrated Faceplate for Electronics Modules In Vehicle Center Console Designed Around Pass-Through Media Slots

(75) Inventors: Marc A. HAYES, Plymouth, MI (US); Yasuhiro UEDA, Novi, MI (US); R. Reid SIGETY, Royal Oak, MI (US)

Correspondence Address: GROSSMAN, TUCKER, PERREAULT & PFLEGER, PLLC, 55 SOUTH COMMERICAL STREET, MANCHESTER, NH, 03101, US

(73) Assignee: COLLINS & AIKMAN PRODUCTS CO., Southfield, MI (US)

(21) Appl. No.: 11/674,066

(22) Filed: Feb. 12, 2007

Related U.S. Application Data
(63) Continuation of application No. PCT/US05/28579, filed on Aug. 12, 2005.
(60) Provisional application No. 60/601,071, filed on Aug. 12, 2004.

(51) Int. Cl. G06F 7/00

(52) U.S. Cl. 701/36

(57) ABSTRACT

An improvement in the fit and finish of a center stack or console area of a vehicle is provided by integrating individual electronic module faceplate and trim bezels into a single faceplate which may be positioned independent of the individual modules. A jumper or flat wire connector provides communication between the controls on the faceplate and the module. A molded alignment guide is provided to direct pass-through media through a slot in the faceplate and into the module.

### CROSS REFERENCE TO RELATED APPLICATIONS

This application is a continuation of International Application No. PCT/US2005/028579 filed Aug. 12, 2005 and published Feb. 23, 2006 as International Publication No. WO 2006/020782, designating the United States, and which claims benefit of the filing date of U.S. Provisional Application No. 60/601,071 filed Aug. 12, 2004, the teachings of which are incorporated herein by reference.

### FIELD OF INVENTION

This invention is directed at the control of electronics modules in a motor vehicle center console, overhead console, center stack and instrument panel using one or more faceplates which are attachably disassociated from the specific module being controlled, and which, in order to minimize tolerance stack-up, include a faceplate designed to align any pass-through media slots with their corresponding chassis. Thus, the fit and finish of the interior of the vehicle is greatly improved by minimizing the number of faceplates and stack-up tolerances between the periphery of mating components by transferring the tolerances to a bezel that bridges the gap between the faceplate and the pass-through media chassis.

### BACKGROUND OF THE INVENTION

Instrument panels or dashboards for modern vehicles (cars, truck, buses, airplanes, boats, etc.) are generally comprised of a series of modules integrated together to form a rather complex cockpit assembly which may be installed as a single unit into a forward portion of the vehicle occupant space. The instrument panel reinforcement structure serves as a skeleton or support base which various major components to be mounted upon, such as a steering column assembly, pedal assembly, glove box, passenger-side air bag assembly, instrument cluster, entertainment/information system, heating/ventilation/air conditioning (HVAC) unit, radio, tape deck, CD player, clock, and telematics devices such as global positioning systems (GPS). The “center stack” area of the vehicle instrument panel generally is where many of these components are “stacked” so that their controls are within easy reach of the driver. The center stack area may comprise a number of these components in vertical alignment in the center of the instrument panel or may comprise a center console, a separate molded structure that contains the components and extends back between the front seats of the vehicle, to provide additional storage capacity as well as an area for the vehicle shifting lever. More recent designs include an overhead console extending along the length of the vehicle at the center line of the headliner and a floor console that extends back between the rear seats.

With the current demand by consumers for additional comfort features in today's motor vehicles and the proliferation of electronic devices in the vehicle, space in the center console area of the vehicle is at a premium. In addition, the center console area comes under close scrutiny by the vehicle occupants for a pleasing fit of components as well as for ease of access, without confusion, to control the multitude of electronically controlled features.

Today's center console area (which may comprise a overhead console, center stack, and floor console between seats) may include the controls for a wide variety of vehicle functions such as the heating/ventilation/air conditioning (HVAC) system, radio, CD player, global positioning system (GPS), telephone, laptop computer, window raising/lowering mechanism, door lock/unlock mechanism, rear window defogger, rear window wiper, side mirror adjustment mechanism, hood release mechanism, trunk latch, cassette player, fog lights, and numerous other comfort and safety features. To interface the switch controls, faceplates, sockets, connectors, plugs and chassis for this myriad of features, the precise location and tolerancing of many molded and assembled subcomponents is required. Since many of these features are dealer options and sold to the consumer as packages, the assembly plant that manufactures the vehicle must schedule and coordinate a large number of variations of trim panels which may include controls for some or all of the various options. Further, substantial assembly time and labor is expended making the hard connections and testing to ensure that the connections are electronically sound.

The use of hard connections between the faceplates, control switches and chassis for these features results in a large stack-up of tolerances due to the multiplicity of mating components and often yields an uneven and unsightly appearance that does not provide an aesthetically pleasing fit where gaps are uniform and adjoining surfaces are flush with each other.

By incorporating a systems integration approach to the center console area of the vehicle, the controls, displays, vents, and storage content of the audio, HVAC, and multifunction systems can be incorporated into one trim bezel, or “faceplate”. With a single faceplate design, there is a significant improvement in the fit and finish of the vehicle interior since only one mating interface is required between faceplate to instrument panel, rather than a stack-up of multiple mating components; such as the radio, HVAC, multifunction switch bank, and trim bezels. To get the same level of fit and finish craftsmanship using current center stack design component methodology would greatly increase piece and tooling costs due to the additional components required. Further, geometric dimensioning and tolerancing (GD&T) would demand additional molded features in the various components. Additionally, by disassociating the faceplate from electronics modules or chassis (using flex circuits, jumpers or wiring harnesses) it is possible to move the electronics modules in some cases out of the instrument panel. A complete plastic structure for the I/P center stack carrier may then be designed to meet all OEM structural requirements while offering advantages in cost and weight, preferably without the need for metal brackets and reinforcements. The center stack structure can then also be designed to provide additional attachment and packaging opportunities for the radio, HVAC, additional media storage, and cup holder.

Each of the major components and modules assembled into the center stack of the vehicle has its own dimensional tolerances which are built into the design, materials and processes used to manufacture and assemble the component or module. Since plastic parts shrink in size upon molding and cooling, this size reduction must be factored into the design of the component to ensure a pleasing fit. Likewise, metal assemblies, such as a radio chassis, are composed of a series of smaller sub-components fitted together, and bring along a stacking of tolerances from each of the individual components. Matching the shrinkage of plastic parts and the stack-up of tolerances on metal assemblies to provide a predictable fit having no gaps or rattles and reliable electrical connectivity is an ongoing problem in the automotive industry.

What is needed is a center console design (center stack, overhead, between seats, etc.) which provides for the control for a multitude of electronics modules to be incorporated into preferably a single faceplate which is disassociated from the modules it controls in a manner which compensates for tolerance stack-up between mating components, while yielding a pleasing appearance to the vehicle occupants, minimizing aggravating rattles during use and providing more reliable electronic connectivity.

It is an object of the present invention to provide a single faceplate for a center stack or console which includes a multitude of human interfaces to provide greatly improved fit and finish appearance and reduced tolerance stack-up.

It is a further object of the present invention to attachably disassociate the faceplate for a center stack or console from the electronic modules, components or chassis that it interfaces with by using jumpers, flexible flat wire harnesses and the like to allow the location of the faceplate to not be controlled by the positioning of the electronics module, component or chassis.

It is a still further object of the present invention to allow the electronics modules, components and chassis to be located remote from the faceplate, even outside of the center stack area to allow the console structure to be molded entirely of plastic and not require steel brackets or reinforcements.

It is a still further object of the present invention to provide a single aesthetically-pleasing faceplate for a center console area which includes the controls and displays for a multitude of features and which is aligned with a pass-through media slot for a DVD, CD, memory stick, memory disc, cassette and the like.

It is a still further object of the present invention to provide an alignment guide or bezel for pass-through media between the faceplate of the current invention and the corresponding chassis which provides a ramp feature for the pass-through media and transfers the stack-up of tolerances from the periphery of the faceplate of the many mating components to the interface between the single faceplate and the pass-through media chassis.

### SUMMARY OF THE INVENTION

An improved fit and finish appearance is provided for a vehicle center stack or console by integrating the faceplates for the myriad of features located therein preferably into a single faceplate. The faceplate is separately positioned relative to the individual electronics modules or chassis, and may include a printed circuit board (PCB) which is electronically connected through jumpers, flat wire connectors or other conductive devices to the various chassis. Any tolerance stack-up is transferred to an alignment bezel which fits between the faceplate and a pass-through media slot to ramp the media into place.

### BRIEF DESCRIPTION OF THE DRAWINGS

For a further understanding of the nature and objects of the present invention, reference should be made to the following detailed description taken in conjunction with the accompanying drawings in which like elements are given the same or analogous reference numbers and wherein:

FIG. 1 is a perspective view of a current vehicle instrument panel containing a number of faceplates for each individual electronics chassis or component.

FIG. 2 is a partial sectional view along line A-A of FIG. 1.

FIG. 3 is a sectional view of the same features but employing the present invention.

FIG. 4 is an exploded perspective view of the present invention.

FIG. 5 is a cut-away top view of the attachment mechanism of the current invention.

FIG. 6 is a sectional view of the alignment guide of the present invention.

### DETAILED DESCRIPTION OF THE INVENTION

Instrument panel assemblies in current motor vehicles are generally a series of modules assembled to a complex molded plastic or composite substructure. The substructure often is reinforced with metal brackets, cross-car beams or composite moldings containing reinforcing materials. The surface of the substructure may be integrally formed of thermoplastic to form a hard panel and may be covered with a soft thin skin of vinyl, urethane or olefin, backed with a soft foam layer, to yield a plush feeling surface.

The molded plastic substructure is generally injection molded due to its complex and varied shape which may include undercuts, dielocks, ribs, bosses and attachment features. In some instances, other processes such as blow molding, compression molding, structural RIM (glass reinforced) urethane and insert-molding of reinforcing beams and brackets have been used. See, e.g., U.S. Pat. Nos. 5,364,159 and 5,556,153 commonly assigned to the assignee of the present invention and included herein by reference.

Often, due to the multitude of requirements placed on these structures, for instance, to provide controlled crush resistance, to sustain high heat loads without deflection, to provide structural support for the steering column, pedal and air bag assemblies, all styled into a smooth pleasing aesthetic appearance, the structure may comprise a series of major modules fastened together. Generally, these may comprise a cross-car beam and instrument panel retainer, cross-car ducting for the HVAC system and a separate center stack assembly housing. Since there are numerous smaller components and modules subsequently attached to the cross-car structure, it is often impossible to mold all the features, angles, die locks, etc. in a single injection mold.

The instrument panel substructure or retainer, whether it comprises an integrated or separate center stack, requires the use of a relatively rigid thermoplastic to meet the aforementioned requirements. Materials such as polycarbonate/acrylonitrile-butadiene-styrene (PC/ABS) blends, polyphenylene oxide, styrene maleic anhydride (SMA), and polypropylene (PP) whether unfilled or filled with talc or glass fibers may fulfill the requirements.

In this invention, preferably either a separate center stack assembly may be attached to a main retainer, or the center stack assembly may be integrally formed as a part of the instrument panel retainer or substructure, to form the mounting openings for components, such as but not limited to, a glove box, radio, CD player, HVAC control module or telematics devices. As this is often the “communications center” of the vehicle, the optimum design must consider such factors as structure, human machine interface, electrical connections and reconfigurability between vehicle platforms.

In addition, while the Figures herein depict an instrument panel center stack area, the present invention is contemplated to provide similar efficiencies in a center floor console or overhead console in a vehicle.

By taking a systems integration approach to the center stack area, the controls, displays, vents and storage center of the audio, HVAC and multi-function systems can be incorporated into, preferably, a single faceplate or trim bezel. With a single faceplate or trim bezel covering this large area, a significant improvement in fit and finish appearance is provided over the prior art of multiple trim plates each attached to the chassis of an electronic component or module resulting in a series of gaps and non-flush conditions due to misalignment. Further, with a single faceplate and the ability to now move some of the modules remote from the their controls, media controls may be moved to higher, more easily accessible positions in the vehicle and provide greater storage space in the vehicle interior. Thus, storage and ergonomics are improved.

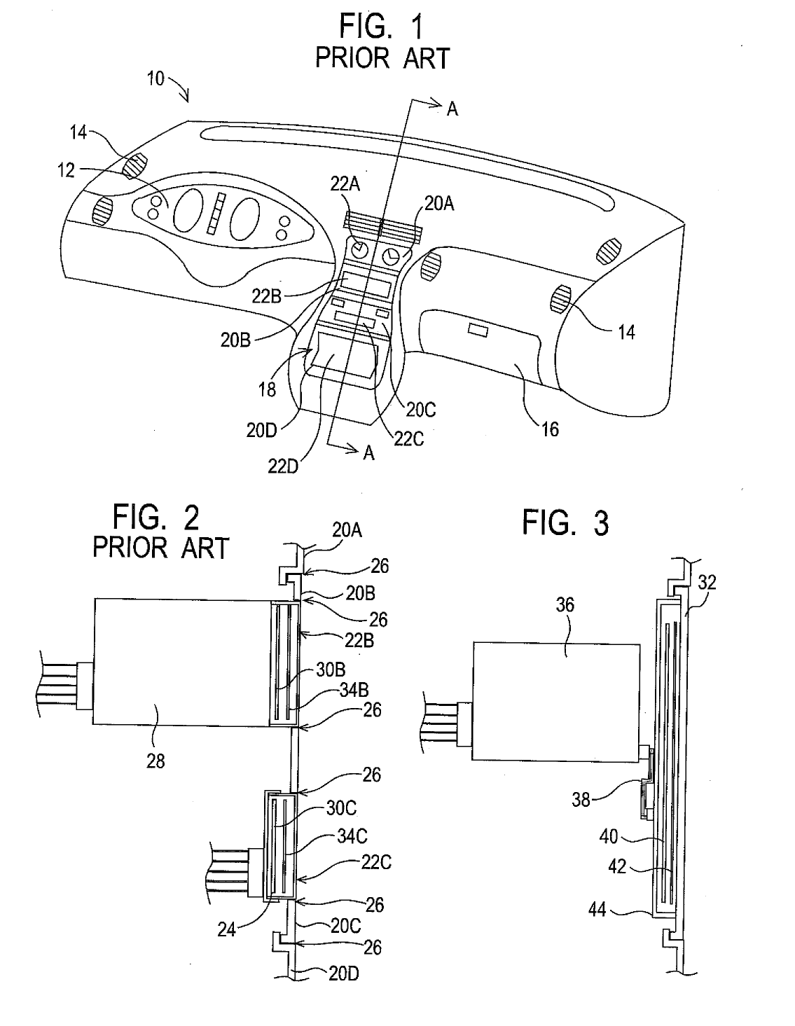

Referring now to FIG. 1, there is illustrated an instrument panel 10 for a motor vehicle comprising an instrument cluster 12, air vents 14, a glove box 16 and a center console or stack area 18. The center console 18 generally comprises a plurality of control switches mounted on faceplates which activate electronics modules stored in the center console/stack area of the instrument panel 10 of the vehicle. These may include, but are not limited to, HVAC controls, radio and CD player controls, GPS controls, a touch screen, etc. FIG. 1 further illustrates a series of separate trim bezels 20A, 20B, 20C and 20D each surrounding the front of the respective electronic component chassis which they control. Each chassis further may include a faceplate 22A, 22B, 22C and 22D.

FIG. 2 shows a cross-sectional view taken along line A-A of FIG. 1 illustrating this in greater detail. Here, trim bezel 20B surrounds at least a portion of an audio module 28 and is separate from the trim bezel 20A directly above it. Likewise, trim bezel 20C at least partially surrounds an HVAC control module 24 and is separate from the faceplate beneath it, 20D. This leads to the presence of a series of interfaces 26 which may become unsightly gaps and non-flush surfaces due to the tolerance stack-up resulting from the molding of multiple faceplates, attaching them to their respective modules and then installing the modules in the center stack structure of the vehicle. FIG. 2 also illustrates that each module 24, 28 may have its own printed circuit board (PCB) 30B, 30C and illumination source 34B, 34C.

FIG. 3 illustrates one embodiment of the present invention, taking the systems integration approach, by combining the faceplates 22B, 22C and trim bezels 20B, 20C into a single faceplate 32 which is disconnected directly from a combined audio/HVAC module 36 and contains all the control features in a single panel 32, having no internal gaps or tolerance stack-up that might lead to an unsightly fit. By disassociating or removing any hard connections from the faceplate 32 to the module 36, the module 36 may be separately positioned relative to the faceplate anywhere in the center stack 18 or instrument panel 10 area or even elsewhere in the vehicle and connected remotely or indirectly by jumper cables 38, wiring harnesses, etc. Thus, the module 36 does not control the location, fit and finish or appearance of the faceplate 32. The faceplate 32 may then also contain one or more PCB's 40 or illumination sources 42. A protective cover 44 for handling and assembly may close out the back side of the faceplate 32 to minimize dirt and damage to the PCB 40. The cover 44 may comprise a plastic film. In addition, the faceplate may also include means to shield EMI, such as a metallized layer or a metallized film either separately applied or an insert-molded into the faceplate.

As shown in FIG. 3, the electronics module 36 is now disassociated from the faceplate 32 and may, in fact, be a combined HVAC/audio module requiring few connections and positioned virtually anywhere in the instrument panel structure or elsewhere in the vehicle. Therefore, it may be possible to now provide a plastic molding for the center stack that does not require additional metal stiffening or bracketry, resulting in reduced cost and weight.

One example of the remote control of an electronics module in the center stack area of a vehicle may be found in International Patent Application PCT/US03/38936, filed Dec. 9, 2003 and entitled “Non-Contact Connection For Electronics Module In Vehicle Center Stack”, assigned to the assignee of the present invention and included herein by reference. This application is directed at the use of infrared signals transmitted from a trim panel or faceplate to the respective electronic module to control the feature without the need for a physical connection.

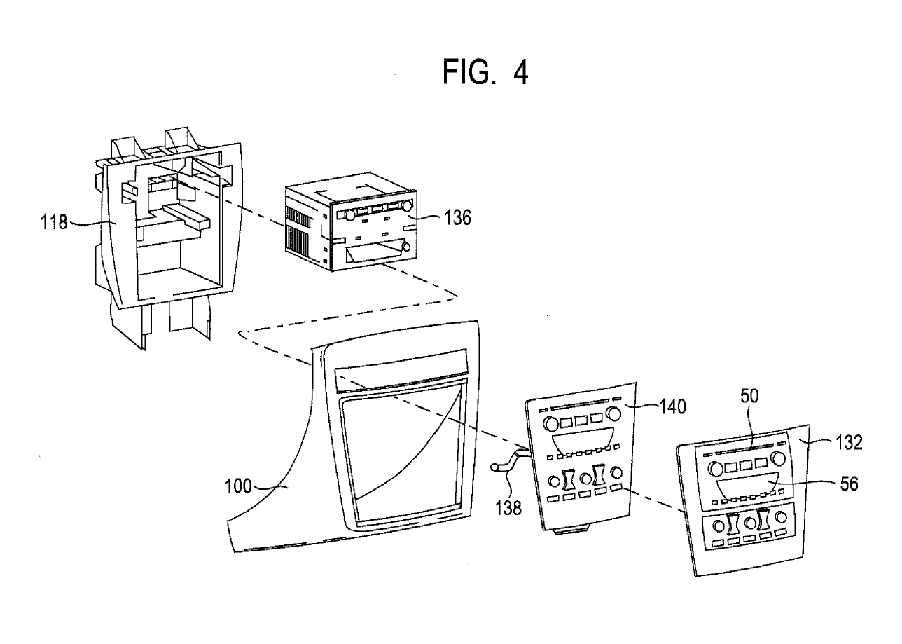

Turning to FIG. 4, an exploded perspective view of the present invention is shown. Here, a single faceplate/trim panel 132 may be connected to a PCB 140 which contains the electronics for controlling a number of the features found in the vehicle. The faceplate 132 may contain control knobs, LED and LCD displays, soft touch screens, a pass-through media slot 50 (such as for a CD or DVD player), and so forth. The PCB 140 may include one or more jumpers, wiring harnesses or preferably flat wire connectors 138 which conduct signals to and from the module 136. The faceplate 132 fits into a lower instrument panel 100 which overlies the center stack structure 118 of the vehicle. One or more electronics modules 136 are preferably slidably mounted into the center stack structure 118 and retained there from rattling or flying loose in the case of an impact.

In addition, since such a large variety of features may reside in or be controlled from a center stack or console area of a vehicle, the faceplate 132 may include a “patch” or generic opening 56 which may provide an optional media slot or area to provide control for any of a variety of assembly plant installed options or consumer installed options. Generally, this “patch” would comprise a simple geometric shape closed out with an easily removable cover plate. In one particular embodiment, the “patch” would comprise a large opening into which an electronics device, such as a laptop computer, personal digital assistant (PDA), cell phone, DVD player, etc. may be brought from the home and easily installed on a frequent basis for accessing data or listening/viewing pleasure. Further, this electronics device may also include its own decorative trim bezel that coordinates with the surrounding panel.

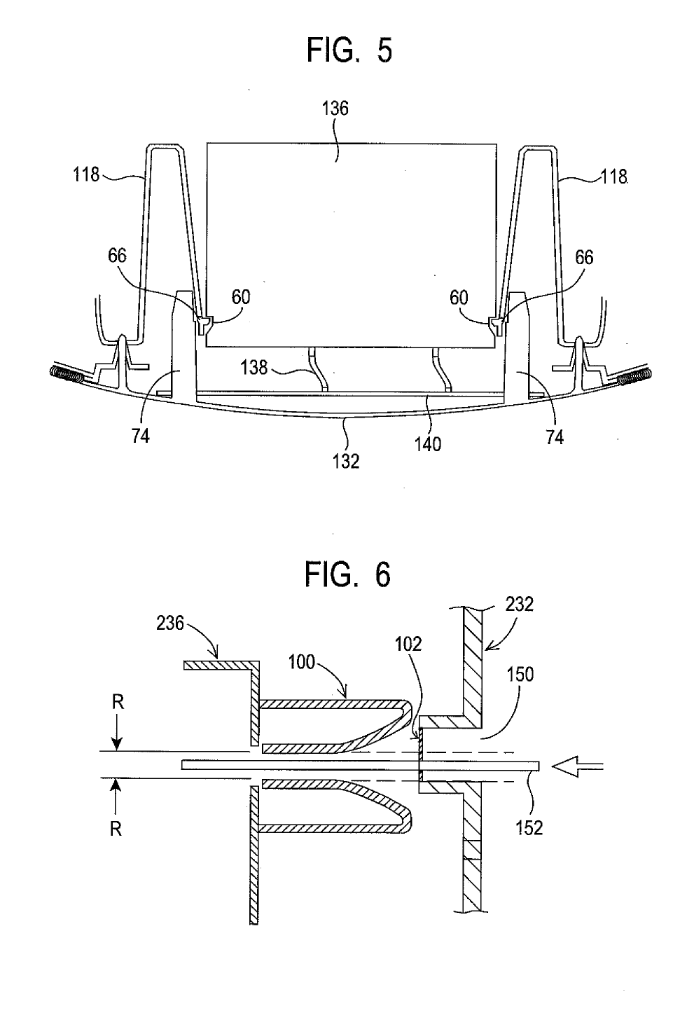

FIG. 5 shows a cut-away top view of the module 136 assembled into a portion of the center stack structure 118 and the preferred relative positioning of the faceplate 132, PCB 140 and module 136. Here, the module 136 is held in place by snap-tabs 66 which fit into corresponding depressions 80 in the chassis of the module to insure retention. The snap tabs 66 may be retained in place by pins 74 which extend from the back of the faceplate 132 and force the snap tabs 66 into the depressions 80 as disclosed in U.S. patent application Ser. No. 10/610,430 filed Jun. 30, 2003 entitled “Integrated Center Stack Electronic Retention System”, assigned to the assignee of the present invention and included herein by reference.

FIG. 6 illustrates a further embodiment of the present invention. Having reduced fit and finish concerns by reducing the tolerance stack-up from multiple faceplates, hard-connected modules and trim bezels with a single disassociated faceplate, one must then be concerned with tolerance stack-up and functionality of any pass-through media devices. Such devices as compact disc (CD) players, digital video disc (DVD) players, cassettes, memory sticks, memory discs, and so forth require reasonable alignment of a pass-through slot in the faceplate with the slot in the module chassis during load and eject functions of the media. FIG. 6 shows the faceplate 232 with a pass-through slot 150 and a disc 152 being loaded into a module 236. The arrows indicated at R describe the range of tolerance for the entrance of disc 152 into the module 236. In order to effectively align the disc 152 for proper load and eject functions with the module 236, an alignment guide or bezel 100 is attached to the module 236 behind the faceplate 232. The guide or bezel 100 is preferably tapered inward as shown to guide or ramp the disc 152 from the wider pass-through slot 150 into the narrower slot R in the chassis.

The guide or bezel 100 is preferably molded from a soft plastic or rubber (thermoplastic rubber, thermoplastic elastomer, thermoplastic urethane, silicone, etc.). Additionally, a felt or soft plastic seal 102 may be provided to block light and close out any vertical gap in the faceplate slot 150. Optionally, the seal 102 may be co-molded with the guide or bezel 100 into a single article.

Preferably, common four-way and two-way locators for the faceplate, module, instrument panel retainer and center stack structure are positioned as close as possible to the electronics module for the CD, etc. and preferably on the centerline of the CD to minimize variation.

The present invention thus provides an improvement in fit and finish in the console area of a vehicle, and a reduction in part count, weight and cost by disassociating electronics modules from the single faceplate as well as a potential for improving the serviceability of the electronic modules in the center stack or console area of a vehicle.

1. A console for a vehicle, said vehicle having an instrument panel and an electrical power system, said console comprising;
(i) a mounting structure in the instrument panel,
(ii) one or more electronics modules mounted in said mounting structure,
(iii) one or more faceplates located in front of said one or more electronics modules, wherein said one or more faceplates contain control devices for activating said one or more electronics modules, and
(iv) one or more conductors for electronically communicating between said one or more electronics modules and said one or more faceplates, wherein said one or more faceplates are connected to said one or more modules through said one or more conductors such that said faceplates may be separately positioned relative to said one or more modules.

2. The console of claim 1 wherein said one or more conductors comprise one or a combination of jumpers, flex circuits, flat wire connectors and wiring harnesses.

3. The console of claim 1 wherein said one or more electronics modules activate one or more of the vehicles' HVAC system, radio, CD player, windows, window locks, mirrors, global positioning system, telephone, rear window wiper, rear window defogger, hood release, trunk latch, cassette player, fog lights, interior lights, head lights, and combinations thereof.

4. The console of claim 1 wherein said control devices comprise switches, knobs and touch screens.

5. (canceled)

6. (canceled)

7. The console of claim 1 wherein one of said one or more faceplates includes a pass-through slot and said one or more electronics modules comprises a pass-through media player having an entry/ejection slot.

8. The console of claim 7, wherein said pass-through media player includes a molded bezel for aligning a pass-through media device through said pass-through slot with said entry/ejection slot.

9. An apparatus for transmitting control signals to an electronics module in a vehicle console having a faceplate for operating an electrical or electro-mechanical device in a vehicle, comprising:
(i) one or more electronics modules mounted in said console
(ii) a faceplate including control devices for one or more electronics modules
(iii) one or more conductors connected to said one or more electronics modules from said faceplate, wherein said one or more modules may be independently positioned relative to said faceplate.

10. The apparatus of claim 9, wherein the vehicle console is located in one or more of an instrument panel, headliner, or between the seats of a vehicle.

11. The apparatus of claim 9, wherein said one or more conductors comprise one or a combination of jumpers, flex circuits, flat wire connectors and wiring harnesses.

12. The apparatus of claim 9, wherein said control devices comprise switches, knobs and touch screens.

13. The apparatus of claim 9, wherein one of said one or more faceplates includes a pass-through slot and said one or more electronics modules comprises a pass-through media player having an entry/ejection slot.

14. The apparatus of claim 13, wherein said pass-through media player includes a molded bezel for aligning a pass-through media device through said pass-through slot with said entry/ejection slot.

15. An alignment bezel for a pass-through media wherein an electronics module includes a receiving slot for said media and a faceplate for said module includes a pass-through media slot and said alignment bezel is disposed between said faceplate and said electronics module to guide said media from said pass-through slot into said receiving slot.

16. The alignment bezel of claim 15, wherein said bezel has converging lateral inner surfaces to guide said media into said receiving slot.

17. The alignment bezel of claim 15, wherein said bezel is molded of a polymer.

18. A vehicle instrument panel assembly comprising:
a structural carrier including a center stack for housing one or more electronic components wherein said center stack contains opposing walls including mounting openings for slidably engaging said one or more components into fixed relationship with said mounting openings;
one or more faceplates mounted in front of said mounting openings;
one or more conductors for electronically communicating between said one or more electronic components and said one or more faceplates;
wherein said one or more faceplates are connected to said one or more modules through said one or more conductors such that said faceplates may be separately positioned relative to said one or more modules.

19. (canceled)

20. (canceled)

21. (canceled)

22. The vehicle instrument panel assembly of claim 18, wherein said one or more component is a compact disc player.

23. (canceled)

24. (canceled)

25. (canceled)

26. (canceled)

27. (canceled)

28. The vehicle instrument panel assembly of claim 18, wherein said one or more component comprises a generic patch for allowing optional components to be connected therethrough.

29. (canceled)

30. (canceled)

31. The vehicle instrument panel of claim 22 wherein said component includes a entry/ejection slot for a media and said one or more faceplates includes a pass-through slot.

32. The instrument panel of claim 31, wherein said pass-through media player includes a molded bezel for aligning a pass-through media device through said pass-through slot with said entry/ejection slot.

33. (canceled)
